(19) United States
(12) Patent Application Publication
(10) Pub. No.: US 2025/0175881 A1
(43) Pub. Date: May 29, 2025

(54) LIMITING ROUTE SELECTION POLICY RULES TO SOME NETWORKS

(71) Applicant: Lenovo (Singapore) Pte. Limited, Singapore (SG)

(72) Inventors: Dimitrios Karampatsis, Ruislip (GB); Andreas Kunz, Ladenburg (DE)

(73) Assignee: Lenovo (Singapore) Pte. Limited, Singapore (SG)

(21) Appl. No.: 18/843,572

(22) PCT Filed: May 4, 2022
(86) PCT No.: PCT/EP2022/062033

§ 371 Date: Sep. 3, 2024

(30) Foreign Application Priority Data
Mar. 4, 2022 (GR) 20220100204

(51) Int. Cl. H04W 40/24

(52) U.S. Cl. CPC H04W 40/246; H04W 40/248

(57) ABSTRACT

There is further provided a user equipment apparatus comprising a receiver, a transmitter and a processor. The receiver is arranged to receive from a first wireless communication network at least one route selection policy rule together with a policy delivery request, wherein the policy delivery request includes a list of network identities for which route selection policy rules provisioned from the first wireless communication network must be applied. The transmitter is arranged to transmit a registration request to a second wireless communication network, where a network identity of the second wireless communication network is not listed in the list of network identities for which route selection policy rules provisioned from the first wireless communication network must be applied. The processor is arranged to not apply route selection policy rules provisioned from the first wireless communication network.

### FIELD

The subject matter disclosed herein relates generally to the field of implementing limiting route selection policy rules to some networks. This document defines a network node, a method in a network node, a user equipment apparatus and a method in a user equipment apparatus.

### BACKGROUND

User Equipment (UE) Route Selection Policy (URSP) rules and the procedures for a UE to apply URSP rules are described in 3GPP TS 23.502 v17.3.0 and 3GPP TS 23.503 v17.3.0. The URSP rules contain a Traffic Descriptor that allows the UE to determine if a URSP rule matches application traffic. Traffic Descriptors include Application Descriptors which may define the operating system identity (OSID) and the application identity (OSAppID). Traffic Descriptors also include IP flow descriptors such as the target address of application traffic, a requested Data Network Name by the application, and/or a connection capability requested by an application (e.g. an IP Multimedia Subsystem (IMS) connection).

A UE with a valid International Mobile Subscriber Identifier may roam from its home public land mobile network (H-PLMN) and access service in the roamed to area by using a visited PLMN (V-PLMN). If a communication has been established, the UE will in principle not suffer an interruption within the PLMN area.

S2-2200401 is a change request in respect of TS 23.503 v17.3.0 submitted by MediaTek Inc. at TSG-SA WG2 e-meeting #149E on 14 Feb. 2022 and proposes that the UE only use the URSP rules signaled by the PCF of the SNPN access with no means for the HPLMN to indicate to the UE if the UE can use URSP rules from the HPLMN. The disadvantage of this approach is that the UE will not be able to use operator services when accessing this SNPN. For example, the operator may wish to route IMS traffic to the HPLMN via an SNPN network via non-3GPP access or via connectivity to SNPN via N3IWF.

S2-2200640 is a 3GPP discussion document titled “Reply LS on PCF in case of SNPN with CH using AUSF/UDM for primary auth” submitted by Huawei at TSG-SA WG2 e-meeting #149E on 14 Feb. 2022 and proposes that: for a UE which can access both a PLMN (when not operating in SNPN access mode) and an SNPN using the PLMN subscription (when operating in SNPN access mode), then for Common URSP: the UE is expected to be (pre-)configured with one URSP applicable regardless whether the UE accesses a PLMN or an SNPN. Whereas for Two URSPs: the UE is expected to be (pre-)configured with one URSP applicable when the UE accesses a SNPN and the other URSP applicable when the UE accesses a PLMN. Such an arrangement would create complexity where there are conflicts between URSP rules. It is not clear from the document which URSP rule has priority.

A Stand-alone Non-Public Network (SNPN) is a wireless communication network operated without relying on network functions provided by a PLMN; a PCF is a Policy Control Function; a CH is a credentials holder; and AUSF/UDM refer to the Authentication Server Function and/or the Unified Data Manager. The credentials holder may be the H-PLMN.

### SUMMARY

A problem with existing UE Route Selection Policy Rules is that they can be only set by the Home PLMN. Further, such rules are applied universally by a UE without regard for which PLMN it is registered with. Different PLMNs may have different traffic profiles and a USRP rule that is helpful for a first PLMN may not be helpful for a second PLMN. Typically, a UE roaming from the first PLMN to the second PLMN would apply the USRP rules from the first PLMN in the second PLMN. This can be disadvantageous.

Disclosed herein are procedures for limiting route selection policy rules to some networks. Said procedures may be implemented by a network node in a wireless communication network, and a user equipment apparatus in a wireless communication network.

There is provided a user equipment apparatus comprising a receiver, a transmitter, and a processor. The receiver is arranged to receive, from a first wireless communication network, at least one route selection policy rule together with a policy delivery request. The policy delivery request includes a list of network identities for which route selection policy rules provisioned from the first wireless communication network must be applied. The transmitter is arranged to transmit a registration request to a second wireless communication network, where a network identity of the second wireless communication network is not listed in the list of network identities for which route selection policy rules provisioned from the first wireless communication network must be applied. The processor is arranged to not apply route selection policy rules provisioned from the first wireless communication network.

There is further provided a method in a user equipment apparatus. The method comprises receiving from a first wireless communication network at least one route selection policy rule together with a policy delivery request, wherein the policy delivery request includes a list of network identities for which route selection policy rules provisioned from the first wireless communication network must be applied. The method further comprises transmitting a registration request to a second wireless communication network, where a network identity of the second wireless communication network is not listed in the list of network identities for which route selection policy rules provisioned from the first wireless communication network must be applied. The method further comprises not applying route selection policy rules provisioned from the first wireless communication network.

There is further provided a network node in a second wireless communication network, the network node comprising a receiver and a processor. The receiver is arranged to receive a registration request from a user equipment apparatus, where a network identity of the second wireless communication network is not listed in a list of network identities for which route selection policy rules provisioned from the first wireless communication network must be applied. The processor is arranged to register the user equipment apparatus with the second wireless communication network.

There is provided a method in a network node in a second wireless communication network. The method comprises receiving a registration request from a user equipment apparatus, where a network identity of the second wireless communication network is not listed in a list of network identities for which route selection policy rules provisioned from the first wireless communication network must be applied. The method further comprises registering the user equipment apparatus with the second wireless communication network.

There is further provided a network node in a third wireless communication network, the network node comprising a receiver and a processor. The receiver is arranged to receive a registration request from a user equipment apparatus, where a network identity of the third wireless communication network is listed in a list of network identities for which route selection policy rules provisioned from the first wireless communication network must be applied. The processor is arranged to register the user equipment apparatus with the third wireless communication network.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for limiting route selection policy rules to some networks will now be described, by way of example only, with reference to the accompanying drawings, in which:

FIG. 1A illustrates a known system of wireless communication networks including an SNPN;

FIG. 1B illustrates a known system of wireless communication networks including a V-PLMN;

FIG. 2 depicts a user equipment apparatus;

FIG. 3 depicts further details of a network node;

FIG. 4 illustrates a method in a network node in a first wireless communication network;

FIG. 5 illustrates a method in a user equipment apparatus;

FIG. 6 illustrates a method in a user equipment apparatus;

FIG. 7 illustrates a method in a network node in a second wireless communication network; and

FIG. 8 is a message sequence chart illustrating a method presented herein.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory

(“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

Since Release 15 of the 3GPP standards onwards URSP rules have been defined to allow a UE to determine how to route application traffic via the mobile communication network either via 3GPP access or via non-3GPP access via an untrusted or trusted WLAN access or route the traffic non-seamlessly bypassing the mobile communication network via a WLAN connection. The URSP rules and the procedures for the UE to apply URSP rules are described in 3GPP TS 23.502 v17.3.0 and 3GPP TS 23.503 v17.3.0 (URSP rules definitions and procedures are included from version 15.0.0 onwards of 23.502 and 23.503). URSP rules are an example of route selection policy rules.

The URSP rules contain a Traffic Descriptor that allows the UE to determine if a URSP rule matches application traffic. Traffic Descriptors include: Application Descriptors (OSID/OSAppID), IP flow descriptors (e.g. target address of application traffic, a requested Data Network Name by the application or a connection capability requested by an application (e.g. an IMS connection).

Each URSP rule contains a Route Selection Descriptor (RSD) that describes to the UE how to route a Packet Data Unit (PDU) session. The RSD includes one or more of the following: Session and Service Continuity Mode Selection, Network Slice Selection, Data Network Name Selection, PDU Session Type Selection, Non-Seamless Offload indication, Access Type preference.

A UE that receives the URSP rule routes the traffic identified by the URSP rule via the PDU session that matches the RSD components identified in the URSP rule via 3GPP or non-3GPP access.

Currently, URSP rules are only provided to a UE from the PCF of the H-PLMN (i.e. H-PCF). A UE uses the URSP rules provisioned by the H-PLMN in any PLMN that the UE may register to. When the UE is roaming, the PCF at the V-PLMN (i.e. V-PCF) is not able to create URSP rules for, or provision URSP rules to, the visiting UE. However, ANDSP (Access Network Discovery and Selection Policy) rules may be created for a visiting UE by the V-PCF and may be provisioned to the visiting UE by the V-PCF. The PCF provisions the UE with URSP and/or ANDSP policies within UE Policy information that is provided to the UE via NAS signaling. The PCF allocates the URSP and ANDSP rules within policy sections within the UE policy information each policy section identified by a specific policy section identifier. The PCF stores the policy sections and policy section identifier in a database which is used as a means for the PCF to determine if the UE requires updated policies. When the UE registers with a PLMN, the UE includes in the registration request to the PLMN the policy section identifiers associated with the policy sections stored in the UE that allows the PCF of the PLMN (in either a home or a visited network) to identify if updated policies are required at the UE.

In addition, in certain private network deployments a UE can register to a Stand-alone Non-Public Network (SNPN) using credentials of a different PLMN. In such scenarios the UE will use the URSP rules from the credential holder but the PCF in the credential holder PLMN will not be able to provide URSP rules to the UE. In such scenarios there are issues on how the UE applies the URSP rules and whether the SNPN network can provide URSP rules to the UE.

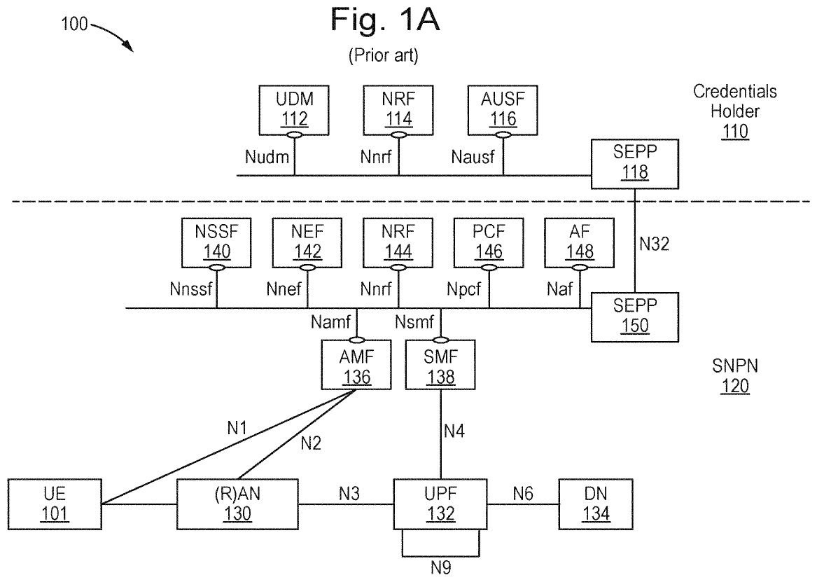

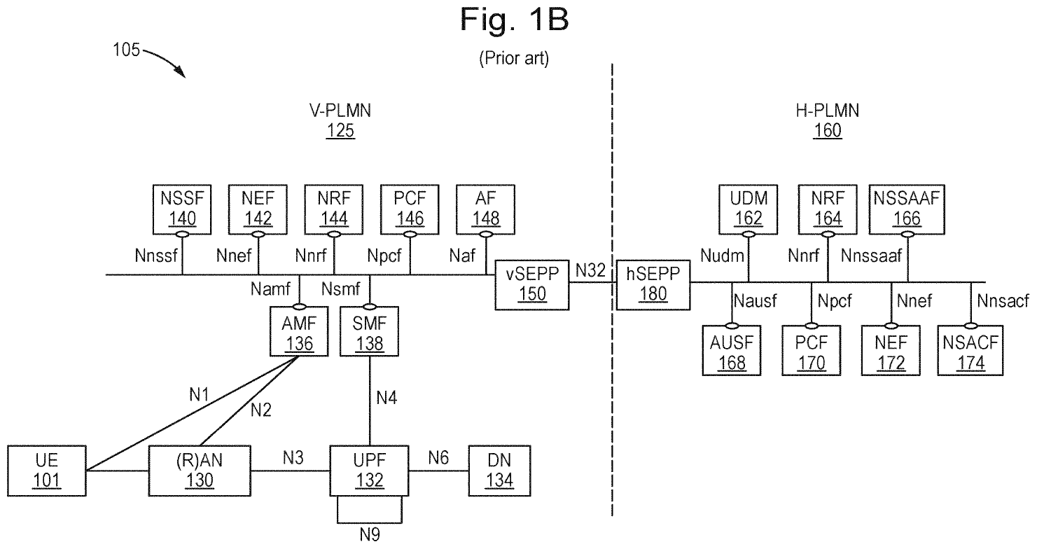

FIG. 1A illustrates a known system 100 of wireless communication networks including an SNPN. The system 100 comprises a User Equipment (UE) 101, a Credentials Holder 110 and an SNPN 120. The Credentials Holder 110 comprises a Unified Data Manager (UDM) 112, a Network Repository Function (NRF) 114, an Authentication Server Function (AUSF) 116, and a Security Edge Protection Proxy (SEPP) 118. The SNPN 120 comprises a Radio Access Network (RAN) 130, a User Plane Function (UPF) 132, a data network (DN) 134, an Access and Mobility management Function (AMF) 136, a Session Management Function (SMF) 138, a Network Slice Selection Function (NSSF) 140, a Network Exposure Function (NEF) 142, a Network Repository Function (NRF) 144, a Policy Control Function (PCF) 146, an Application Function (AF) 148, and a Security Edge Protection Proxy (SEPP) 150.

The function of the RAN 130 may be fulfilled by some other Access Network, that may not use radio. The UE 101 communicates with the AMF 136 using an N1 interface. The RAN 130 communicates with the AMF 136 using the N2 interface. The RAN 130 communicates with the UPF 132 using the N3 interface. An N9 interface allows communication between UPF's 132. The DN 134 communicates with the UPF 132 using an N6 interface. The UPF 132 communicates with the SMF 138 using an N4 interface. The SEPPs of each network communicate using an N32 interface. Each of UDM 112, NRF 114, AUSF 116, AMF 136, SMF 138, NSSF 140, NEF 142, NRF 144, PCF 146, AF 148 communicate with the network using respective interfaces.

FIG. 1B illustrates a known system 105 of wireless communication networks including a V-PLMN. The system comprises a User Equipment (UE) 101, a V-PLMN 125 and an H-PLMN 160. The H-PLMN 160 comprises a Unified Data Manager (UDM) 162, a Network Repository Function (NRF) 164, a Network Slice-Specific Authentication and Authorization Function (NSSAAF) 166, an Authentication Server Function (AUSF) 168, a Policy Control Function (PCF) 170, a Network Exposure Function (NEF) 172, a Network Slice Access Control Function (NSACF) 174, and a home Security Edge Protection Proxy (hSEPP) 180. The V-PLMN 125 comprises a Radio Access Network (RAN) 130, a User Plane Function (UPF) 132, a data network (DN) 134, an Access and Mobility management Function (AMF) 136, a Session Management Function (SMF) 138, a Network Slice Selection Function (NSSF) 140, a Network Exposure Function (NEF) 142, a Network Repository Function (NRF) 144, a Policy Control Function (PCF) 146, an Application Function (AF) 148, and a visited Security Edge Protection Proxy (SEPP) 150.

The function of the RAN 130 may be fulfilled by some other Access Network, that may not use radio. The UE 101 communicates with the AMF 136 using an N1 interface. The RAN 130 communicates with the AMF 136 using the N2 interface. The RAN 130 communicates with the UPF 132 using the N3 interface. An N9 interface allows communication between UPF's 132. The DN 134 communicates with the UPF 132 using an N6 interface. The UPF 132 communicates with the SMF 138 using an N4 interface. The SEPPs of each network communicate using an N32 interface. Each of UDM 162, NRF 164, NSSAAF 166, AUSF 168, PCF 170, NEF 172, and NSACF 174 communicate with the network using respective interfaces.

As part of Release 18 work, there are also scenarios where a VPLMN may require specific route selection policies for roaming UEs.

The present application presents some solutions to this problem. The solutions presented herein tend to allow a VPLMN to be aware that URSP rules can be provided to the UE. Further, the solutions presented herein tend to allow the HPLMN to control with which PLMNs the UE can use the rules provided by the HPLMN, and also how the HPLMN indicates to the UE to which PLMNs the UE can use the HPLMN provided rules with.

To address the above issues, the HPLMN may indicate to the UE with which PLMNs the UE can use UE policies from the HPLMN. Such an indication may be delivered by providing a list of PLMNs for each provisioned UE policy. When the UE registers to a PLMN that is not within the list of PLMNs the UE does not use the HPLMN provided policies and instead uses only the VPLMN provided ones.

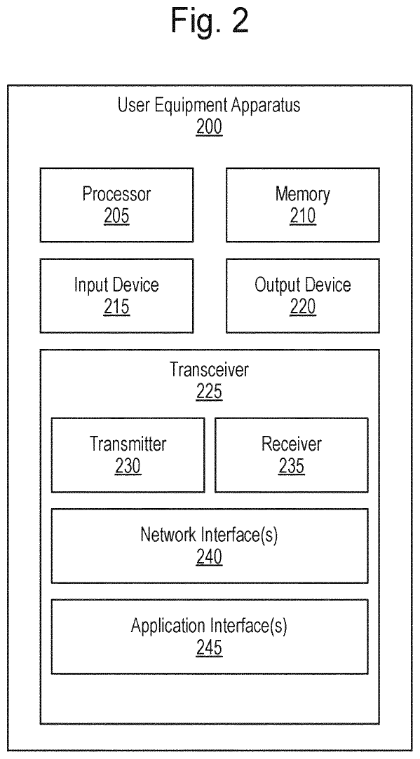

FIG. 2 depicts a user equipment apparatus 200 that may be used for implementing the methods described herein. The user equipment apparatus 200 is used to implement one or more of the solutions described above. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225. The processor 205 may control the user equipment apparatus 200 to implement

the above-described UE behaviors. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as describe above. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide UL communication signals to a base unit of a wireless communications network. Similarly, the one or more receivers 235 may be used to receive DL communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

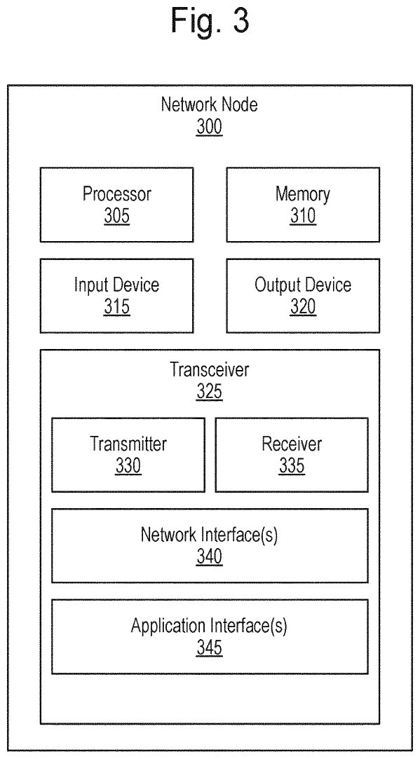

FIG. 3 depicts further details of the network node 300 that may be used for implementing the methods described herein. The network node 300 may be one implementation of an entity in the wireless communications network. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described above. The memory 310 may also stores program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

There is further provided a network node in a first wireless communication network, the network node comprising a receiver a processor and a transmitter. The network node may be a network node 300 comprising a processor 305, a transmitter 330 and a receiver 335. The network node may be a PCF. The network node may be a Home PCF 170, 816. The receiver is arranged to receive an indication from a user equipment apparatus that the user equipment apparatus requires route selection policy rules, wherein the user equipment apparatus is a subscriber to the first wireless communication network. The processor is arranged to determine a list of network identities, each network identity identifying a wireless communication network that the network node is authorized to set route selection policy rules for the user equipment apparatus to apply when connected to the wireless communication network. The transmitter is arranged to send at least one route selection policy rule to the user equipment apparatus together with a policy delivery request, wherein the policy delivery request includes the list of network identities for which route selection policy rules provisioned from the network node must be applied.

The first wireless communication network is a home network of the user equipment apparatus. The policy delivery request may comprise, for each route selection policy rule sent to the user equipment apparatus, a list of network identities identifying in which networks the route selection policy rule must be applied.

The indication that the user equipment apparatus requires route selection policy rules may be a registration request. The registration request may be received from the user equipment apparatus. The indication that the user equipment apparatus requires route selection policy rules may be a route selection policy rule update request. The route selection policy rule update request may be received from the user equipment apparatus. The indication may comprise a list of Policy Section Identifier. The network node may determine from the received Policy Section Identifiers that the user equipment apparatus requires updated URSP rules.

The route selection policy rules may be provided using a UE Configuration Update. The UE Configuration updated may be for transparent policy delivery.

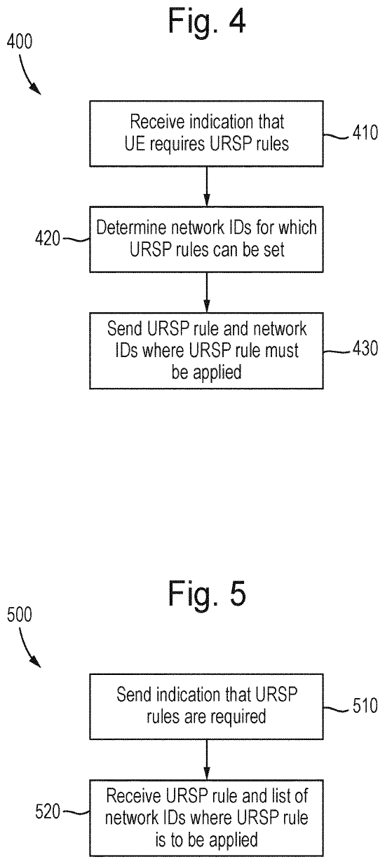

FIG. 4 illustrates a method 400 in a network node in a first wireless communication network. The network node may be a network node 300. The network node may be a PCF. The network node may be a Home PCF 170, 816. The method 400 comprises receiving 410 an indication from a user equipment apparatus that the user equipment apparatus requires route selection policy rules, wherein the user equipment apparatus is a subscriber to the first wireless communication network. The method further comprises determining 420 a list of network identities, each network identity identifying a wireless communication network that the network node is authorized to set route selection policy rules for the user equipment apparatus to apply when connected to the wireless communication network. The method further comprises sending 430 at least one route selection policy rule to the user equipment apparatus together with a policy delivery request, wherein the policy delivery request includes the list of network identities for which route selection policy rules provisioned from the network node must be applied.

The first wireless communication network is a home network of the user equipment apparatus. The policy delivery request may comprise, for each route selection policy rule sent to the user equipment apparatus, a list of network identities identifying in which networks the route selection policy rule must be applied.

The user equipment apparatus requires route selection policy rules may be a registration request. The registration request may be received from the user equipment apparatus. The indication that the user equipment apparatus requires route selection policy rules may be a route selection policy rule update request. The route selection policy rule update request may be received from the user equipment apparatus. The indication may comprise a list of Policy Section Identifier. The network node may determine from the received Policy Section Identifiers that the user equipment apparatus requires updated URSP rules.

The network node may be a policy control function (PCF). The PCF may be a Home-PCF. The route selection policy rules may be provided using a UE Configuration Update. The UE Configuration updated may be for transparent policy delivery.

There is further provided a user equipment apparatus comprising a transmitter and a receiver. The user equipment apparatus may be a UE 101, 200, and/or 812 as described herein. The user equipment apparatus may comprise a processor 205, a transmitter 230 and a receiver 235. The transmitter is arranged to send to a first wireless communication network an indication that the user equipment apparatus requires route selection policy rules, wherein the user equipment apparatus is a subscriber to the first wireless communication network. The receiver is arranged to receive at least one route selection policy rule from the first wireless communication network together with a policy delivery request, wherein the policy delivery request includes a list of network identities for which route selection policy rules provisioned from the first wireless communication network must be applied.

The indication that the user equipment apparatus requires route selection policy rules may be a registration request. The registration request may be received from the user equipment apparatus. The indication that the user equipment apparatus requires route selection policy rules may be a route selection policy rule update request. The route selection policy rule update request may be received from the user equipment apparatus.

The network node may be a Policy Control Function (PCF). The PCF may be a Home-PCF. The route selection policy rules and list of network identities may be provided using a UE Configuration Update. The UE Configuration updated may be for transparent policy delivery.

The transmitter may be further arranged to transmit a subsequent registration to a second wireless communication network, the second wireless communication network having a network identity not listed in the list of network identities for which route selection policy rules provisioned from the first wireless communication network must be applied. The user equipment apparatus may further comprise a processor arranged to not apply route selection policy rules provisioned from the first wireless communication network when the user equipment apparatus is registered to the second wireless communication network.

The processor may be arranged to determine that the second wireless communication network is not identified in the list of network identities for which route selection policy rules provisioned from the first wireless communication network must be applied.

The transmitter may be further arranged to request route selection policy rules from the second wireless communication network. The processor may be further arranged to apply any route selection policy rules received from the second wireless communication network when the user equipment apparatus is registered to the second wireless communication network.

The processor may be further arranged to apply any rules received from an access network discovery and selection function (ANDSF) of the second wireless communication network. Rules from the ANDSF are not route selection policy rules as described herein.

The transmitter may be further arranged to transmit a subsequent registration to a third wireless communication network, the third wireless communication network having a network identity listed in the list of network identities for which route selection policy rules provisioned from the first wireless communication network must be applied. The user equipment apparatus may further comprise a processor arranged to apply route selection policy rules provisioned from the first wireless communication network when the user equipment apparatus is registered to the third wireless communication network.

The processor may be arranged to determine that the third wireless communication network is identified in the list of network identities for which route selection policy rules provisioned from the first wireless communication network must be applied.

The processor may be further arranged to ignore any route selection policy rules received from the third wireless communication network when the user equipment apparatus is registered to the third wireless communication network. The processor may be further arranged to apply any rules received from an access network discovery and selection function (ANDSF) of the third wireless communication network.

FIG. 5 illustrates a method 500 in a user equipment apparatus. The user equipment apparatus may be a UE 101, 200, and/or 812 as described herein. The method 500 comprises sending 510 to a first wireless communication network an indication that the user equipment apparatus requires route selection policy rules, wherein the user equipment apparatus is a subscriber to the first wireless communication network. The method further comprises receiving 520 at least one route selection policy rule from the first wireless communication network together with a policy delivery request, wherein the policy delivery request includes a list of network identities for which route selection policy rules provisioned from the first wireless communication network must be applied.

The indication that the user equipment apparatus requires route selection policy rules may be a registration request. The registration request may be received from the user equipment apparatus. The indication that the user equipment apparatus requires route selection policy rules may be a route selection policy rule update request. The route selection policy rule update request may be received from the user equipment apparatus.

The network node may be a Policy Control Function (PCF). The PCF may be a Home-PCF. The route selection policy rules and list of network identities may be provided using a UE Configuration Update. The UE Configuration updated may be for transparent policy delivery.

The method may further comprise transmitting a subsequent registration to a second wireless communication network, the second wireless communication network having a network identity not listed in the list of network identities for which route selection policy rules provisioned from the first wireless communication network must be applied. The method may further comprise not applying route selection policy rules provisioned from the first wireless communication network when the user equipment apparatus is registered to the second wireless communication network.

The method may further comprise determining that the second wireless communication network is not identified in the list of network identities for which route selection policy rules provisioned from the first wireless communication network must be applied.

The method may further comprise requesting route selection policy rules from the second wireless communication network.

The method may further comprise applying any route selection policy rules received from the second wireless communication network when the user equipment apparatus is registered to the second wireless communication network. The method may further comprise applying any rules received from an access network discovery and selection function (ANDSF) of the second wireless communication network.

The method may further comprise transmitting a subsequent registration to a third wireless communication network, the third wireless communication network having a network identity listed in the list of network identities for which route selection policy rules provisioned from the first wireless communication network must be applied. The method may further comprise applying route selection policy rules provisioned from the first wireless communication network when the user equipment apparatus is registered to the third wireless communication network. The method may further comprise determining that the third wireless communication network is identified in the list of network identities for which route selection policy rules provisioned from the first wireless communication network must be applied.

The method may further comprise ignoring any route selection policy rules received from the third wireless communication network when the user equipment apparatus is registered to the third wireless communication network. The method may further comprise applying any rules received from an access network discovery and selection function (ANDSF) of the third wireless communication network.

There is further provided a user equipment apparatus comprising a receiver, a transmitter and a processor. The user equipment apparatus may be a UE 101, 200, and/or 812 as described herein. The user equipment apparatus may comprise a processor 205, a transmitter 230 and a receiver 235. The receiver is arranged to receive from a first wireless communication network at least one route selection policy rule together with a policy delivery request, wherein the policy delivery request includes a list of network identities for which route selection policy rules provisioned from the first wireless communication network must be applied. The transmitter is arranged to transmit a registration request to a second wireless communication network, where a network identity of the second wireless communication network is not listed in the list of network identities for which route selection policy rules provisioned from the first wireless communication network must be applied. The processor is arranged to not apply route selection policy rules provisioned from the first wireless communication network.

The first wireless communication network is a home network of the user equipment apparatus.

The policy delivery request may comprise, for each route selection policy rule sent to the user equipment apparatus, a list of network identities identifying in which networks the route selection policy rule must be applied. The second wireless communication network is a visited wireless communication network.

The processor being arranged to not apply route selection policy rules provisioned from the first wireless communication network may comprise the processor being arranged to inactivate the route selection policy rules provisioned from the first wireless communication network. The inactivated rules may be reactivated if the user equipment apparatus subsequently registers with the first wireless communication network.

Not applying route selection policy rules provisioned from the first wireless communication network may comprise disabling the route selection policy rules provisioned from the first wireless communication network. The disabled rules may be enabled upon the user equipment apparatus subsequently re-registering with the first wireless communication network.

Not applying route selection policy rules provisioned from the first wireless communication network may comprise discarding route selection policy rules provisioned from the first wireless communication network. The user equipment apparatus may request replacement rules from the first wireless communication network upon re-registering with the first wireless communication network.

The transmitter may be further arranged to request local route selection policy rules from the second wireless communication network. Subsequent to the transmitter sending a request for local route selection policy rules, the receiver of the user equipment apparatus may be arranged to receive local route selection policy rules received from the second wireless communication network.

The processor may be further arranged to apply any local route selection policy rules received from the second wireless communication network. The processor may be further arranged to apply any rules received from an access network discovery and selection function (ANDSF) of the second wireless communication network. Any rules received from the second wireless communication network may be deleted when the user equipment apparatus de-registers from the second wireless communication network.

The transmitter may be further arranged to transmit a subsequent registration to a third wireless communication network, the third wireless communication network having a network identity listed in the list of network identities for which route selection policy rules provisioned from the first wireless communication network must be applied. The user equipment apparatus may further comprising a processor arranged to apply route selection policy rules provisioned from the first wireless communication network when the user equipment apparatus is registered to the third wireless communication network.

The processor may be further arranged to ignore any route selection policy rules received from the third wireless communication network. The processor may be further arranged to apply any rules received from an access network discovery and selection function (ANDSF) of the third wireless communication network.

Alternatively, when transmitting a subsequent registration to a third wireless communication network, the transmitter may indicate that local route selection policy rules are required. The processor may be further arranged to give priority to any local route selection polices received from the third wireless communication network, but to also apply route selection policy rules provisioned from the first wireless communication network.

The transmitter may be further arranged to send to the first wireless communication network an indication that the user equipment apparatus requires route selection policy rules. The at least one route selection policy rule together with a policy delivery request may be received in response to the indication that the user equipment apparatus requires route selection policy rules is a registration request. The indication may comprise a registration request. The indication may be a route selection policy rule update request.

The route selection policy rules may be received using a UE Configuration Update. The UE Configuration updated may be for transparent policy delivery.

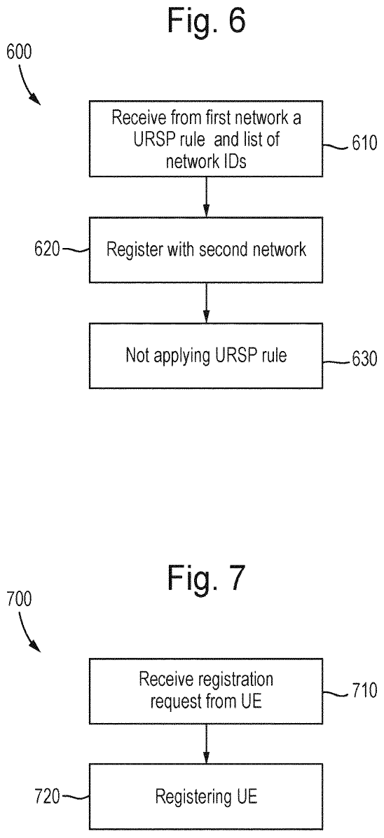

FIG. 6 illustrates a method 600 in a user equipment apparatus. The user equipment apparatus may be a UE 101, 200, and/or 812 as described herein. The user equipment apparatus may comprise a processor 205, a transmitter 230 and a receiver 235. The method 600 comprises receiving 610 from a first wireless communication network at least one route selection policy rule together with a policy delivery request, wherein the policy delivery request includes a list of network identities for which route selection policy rules provisioned from the first wireless communication network must be applied. The method 600 further comprises transmitting 620 a registration request to a second wireless communication network, where a network identity of the second wireless communication network is not listed in the list of network identities for which route selection policy rules provisioned from the first wireless communication network must be applied. The method 600 further comprises not applying 630 route selection policy rules provisioned from the first wireless communication network.

The first wireless communication network is a home network of the user equipment apparatus. The policy delivery request may comprise, for each route selection policy rule sent to the user equipment apparatus, a list of network identities identifying in which networks the route selection policy rule must be applied. The second wireless communication network is a visited wireless communication network.

Not apply route selection policy rules provisioned from the first wireless communication network comprise inactivating the route selection policy rules provisioned from the first wireless communication network. The inactivated rules may be reactivated if the user equipment apparatus subsequently registers with the first wireless communication network.

Not applying route selection policy rules provisioned from the first wireless communication network may comprise disabling the route selection policy rules provisioned from the first wireless communication network. The disabled rules may be enabled upon the user equipment apparatus subsequently re-registering with the first wireless communication network.

Not applying route selection policy rules provisioned from the first wireless communication network may comprise discarding route selection policy rules provisioned from the first wireless communication network. The user equipment apparatus may request replacement rules from the first wireless communication network upon re-registering with the first wireless communication network.

The method may further comprise requesting local route selection policy rules from the second wireless communication network. Subsequent to the transmitter sending a request for local route selection policy rules, the receiver of the user equipment apparatus may be arranged to receive local route selection policy rules received from the second wireless communication network.

The method may further comprise applying any local route selection policy rules received from the second wireless communication network. The processor may be further arranged to apply any rules received from an access network discovery and selection function (ANDSF) of the second wireless communication network. Any rules received from the second wireless communication network may be deleted when the user equipment apparatus de-registers from the second wireless communication network.

The method may further comprise transmitting a subsequent registration to a third wireless communication network, the third wireless communication network having a network identity listed in the list of network identities for which route selection policy rules provisioned from the first wireless communication network must be applied. The method may further comprise applying route selection policy rules provisioned from the first wireless communication network when the user equipment apparatus is registered to the third wireless communication network.

The method may further comprise ignoring any route selection policy rules received from the third wireless communication network. The method may further comprise applying any rules received from an access network discovery and selection function (ANDSF) of the third wireless communication network.

Alternatively, when transmitting a subsequent registration to a third wireless communication network, the transmission may indicate that local route selection policy rules are required. Route selection policy rules provisioned from the first wireless communication network may be applied, with priority given to any local route selection polices received from the third wireless communication network.

The method may further comprise sending to the first wireless communication network an indication that the user equipment apparatus requires route selection policy rules.

The at least one route selection policy rule together with a policy delivery request may be received in response to the indication that the user equipment apparatus requires route selection policy rules is a registration request. The indication may comprise a registration request. The indication may be a route selection policy rule update request.

The route selection policy rules may be received using a UE Configuration Update. The UE Configuration updated may be for transparent policy delivery.

There is further provided a network node in a second wireless communication network. The network node may be a network node 300 comprising a processor 305, a transmitter 330 and a receiver 335. The network node may be a Visited PCF 146, 826. The network node comprises a receiver and a processor. The receiver is arranged to receive a registration request from a user equipment apparatus, where a network identity of the second wireless communication network is not listed in a list of network identities for which route selection policy rules provisioned from the first wireless communication network must be applied. The processor is arranged to register the user equipment apparatus with the second wireless communication network.

The user equipment apparatus is arranged to receive from a first wireless communication network at least one route selection policy rule together with a policy delivery request, wherein the policy delivery request includes the list of network identities for which route selection policy rules provisioned from the first wireless communication network must be applied. The first wireless communication network is a home network of the user equipment apparatus. The policy delivery request may comprise, for each route selection policy rule sent to the user equipment apparatus, a list of network identities identifying in which networks the route selection policy rule must be applied. The second wireless communication network is a visited wireless communication network.

The receiver may be further arranged to receive a request for local route selection policy rules from the user equipment apparatus, and in response thereto, a transmitter of the network node is arranged to send local route selection policy rules to the user equipment apparatus.

Local route selection policy rules may be preconfigured at the network node. The user equipment apparatus may be an inbound roaming device. Local route selection policy rules may be configured per network, e.g. based on Service Level Agreements.

The user equipment apparatus may be arranged to apply any local route selection policy rules received from the second wireless communication network. The user equipment apparatus may be further arranged to apply any rules received from an access network discovery and selection function (ANDSF) of the second wireless communication network. Any rules received from the second wireless communication network may be deleted when the user equipment apparatus de-registers from the second wireless communication network.

The network node may send to the first wireless communication network a request for authorization to provide local route selection policy rules to the user equipment apparatus. The network node may be arranged to send local route selection policy rules to the user equipment apparatus in response to receiving authorization from the first wireless communication network.

The user equipment apparatus may be arranged to apply route selection policy rules received from the network node with a higher priority than those provisioned from the first wireless communication network.

The local route selection policy rules are sent using a UE Configuration Update. The UE Configuration updated may be for transparent policy delivery.

FIG. 7 illustrates a method 700 in a network node in a second wireless communication network. The network node may be a network node 300. The network node may be a Visited PCF 146, 826. The method 700 comprises receiving 710 a registration request from a user equipment apparatus, where a network identity of the second wireless communication network is not listed in a list of network identities for which route selection policy rules provisioned from the first wireless communication network must be applied. The method 700 further comprises registering 720 the user equipment apparatus with the second wireless communication network.

The method may further comprise receiving a request for local route selection policy rules from the user equipment apparatus, and in response thereto, sending local route selection policy rules to the user equipment apparatus.

The user equipment apparatus may be arranged to receive from a first wireless communication network at least one route selection policy rule together with a policy delivery request, wherein the policy delivery request includes the list of network identities for which route selection policy rules provisioned from the first wireless communication network must be applied. The first wireless communication network is a home network of the user equipment apparatus. The policy delivery request may comprise, for each route selection policy rule sent to the user equipment apparatus, a list of network identities identifying in which networks the route selection policy rule must be applied. The second wireless communication network is a visited wireless communication network.

The method may further comprise receiving a request for local route selection policy rules from the user equipment apparatus, and in response thereto, sending local route selection policy rules to the user equipment apparatus. Local route selection policy rules may be preconfigured at the network node. The user equipment apparatus may be an inbound roaming device. Local route selection policy rules may be configured per network, e.g. based on Service Level Agreements.

The user equipment apparatus may be arranged to apply any local route selection policy rules received from the second wireless communication network. The user equipment apparatus may be further arranged to apply any rules received from an access network discovery and selection function (ANDSF) of the second wireless communication network. Any rules received from the second wireless communication network may be deleted when the user equipment apparatus de-registers from the second wireless communication network.

The method may further comprise sending to the first wireless communication network a request for authorization to provide local route selection policy rules to the user equipment apparatus. The method may further comprise sending local route selection policy rules to the user equipment apparatus in response to receiving authorization from the first wireless communication network.

The user equipment apparatus may be arranged to apply route selection policy rules received from the network node with a higher priority than those provisioned from the first wireless communication network.

The local route selection policy rules may be sent using a UE Configuration Update. The UE Configuration updated may be for transparent policy delivery.

### Clauses for V-PCF in Third Wireless Communication Network

There is further provided a network node in a third wireless communication network, the network node comprising: a receiver arranged to receive a registration request from a user equipment apparatus, where a network identity of the third wireless communication network is listed in a list of network identities for which route selection policy rules provisioned from the first wireless communication network must be applied; and a processor arranged to register the user equipment apparatus with the third wireless communication network.

The user equipment apparatus may be arranged to ignore any route selection policy rules received from the third wireless communication network. The processor may be further arranged to apply any rules received from an access network discovery and selection function (ANDSF) of the third wireless communication network.

Alternatively, when transmitting a subsequent registration to a third wireless communication network, the transmitter may indicate that local route selection policy rules are required. The processor may be further arranged to give priority to any local route selection polices received from the third wireless communication network, but to also apply route selection policy rules provisioned from the first wireless communication network.

The network node in a third wireless communication network may send, to the first wireless communication network, service specific information. The service specific information may allow the first wireless communication network to generate route selection policy rules suitable for the third wireless communication network.

The network node may be arranged to receive from the user equipment apparatus an indication that the user equipment apparatus requires route selection policy rules.

The at least one route selection policy rule together with a policy delivery request may be received in response to the indication that the user equipment apparatus requires route selection policy rules is a registration request. The indication may comprise a registration request. The indication may be a route selection policy rule update request.

According to certain arrangements presented herein, an H-PLMN may provide configuration information defining the PLMNs that a UE can request URSP rules from. For example, when the PCF in the H-PLMN (H-PCF) provides UE policies including URSP rules to the UE, the H-PCF includes information on which PLMNs the UE should apply the URSP rules received from the H-PCF. This supports filtering per URSP rules and/or indicating a list of PLMNs where URSP rules provisioned by the H-PLMN can be used. Additionally or alternatively, this supports filtering per Policy Section Identifier and/or UE Policy; included in UE policies provisioned to the UE is a list of PLMNs associated to each Policy Section Identifier of a UE policy. The list of PLMNs may include PLMN and/or SNPN identities.

The UE may have stored UE policies containing multiple policy sections where each policy section is identified by a policy section identifier. Each policy section identifier includes a PLMN identifier indicating the PLMN that provisioned the UE policies to the UE.

Where filtering per URSP rules is performed; indicating a list of PLMNs where URSP rules provisioned by the H-PLMN can be used, then the following may be applied.

The UE applies the H-PLMN provided URSP rules when the UE is registered/or registering to a PLMN that is within the list of PLMNs where URSP rules provisioned by the H-PLMN can be used.

If the UE is registered to a V-PLMN/SNPN and receives UE policies that contain URSP rules from a listed V-PLMN/SNPN that is within the “list of PLMNs where URSP rules provisioned by HPLMN can be used”, the UE ignores the URSP rules from the listed V-PLMN/SNPN. The UE may include in a response an indication for the reason to ignore the rules. If the UE receives UE policies that contains ANDSP rules from the listed V-PLMN/SNPN the UE applies the ANDSP rules as normal.

When the UE is registering to an un-listed V-PLMN/SNPN which is not “within the PLMN list where URSP rules provisioned by H-PLMN can be used”, then the UE determines that the UE must use URSP policies from this un-listed PLMN and not use URSP policies provided by the Home PLMN. In such scenario the UE may include an indication/request for URSP rules from the un-listed PLMN/SNPN with which it is registering. This may be supported by:
Including an indication within the UE Policy Container in the registration request that it requests new/temporary URSP rules; and/or
Including an indication and a generic NAS message (including a UE policy container) requesting new/temporary URSP rules.

When the PCF in the un-listed V-PLMN or SNPN receives the indication/request from the UE the PCF provides local URSP rules to the UE. The PCF assigns a Policy Section Identifier including the SNPN or PLMN identifier and provides the policies to the UE using the UE configuration update procedure for transparent policy delivery.

When the UE is registered to a V-PLMN/SNPN and receives local URSP rules from the un-listed V-PLMN/SNPN which is not within the list of PLMNs the UE applies only V-PLMN/SNPN URSP rules and does not apply any URSP rules or policies provided by the H-PLMN. When the UE de-registers from the V-PLMN/SNPN the UE does not need to store the local URSP rules.

Where filtering is performed by Policy Section Identifier and/or UE Policy, then included in the UE policies provisioned to the UE is a list of PLMNs associated to each Policy Section Identifier of a UE policy. In this situation the following may be applied.

The UE applies the H-PLMN provided UE policies when the UE is registered/or registering to a PLMN that is within the list of PLMNs associated to the PSI identifier. The PSI identifier is a Public Service Identity (PSI) which is used to identify services which are hosted by an AS (Application Server).

If the UE is registered to a V-PLMN/SNPN and receives UE Policies from the V-PLMN/SNPN that is within the list of PLMNs the UE gives priorities to the VPMN/SNPN policies but also applies the UE policies of the home PLMN. It should be noted that in such a scenario the V-PLMN/SNPN may not provide any local URSP rules.

When the UE is registering to a PLMN (i.e. V-PLMN or SNPN) which is not within the PLMN list, then the UE determines that the UE must use UE policies from this PLMN and not use UE policies provided by the home PLMN. In such scenario the UE may include an indication/request for UE policies from the PLMN/SNPN it is registering with. This can be supported by including an indication within the UE Policy Container in the registration request that the UE requests new/temporary policies.

When the PCF in the V-PLMN or SNPN receives the indication/request from the UE the PCF provides local UE policies including URSP rules to the UE. Those local UE policies may be preconfigured in the PCF for inbound roamers. The PCF assigns a Policy Section Identifier including the SNPN or PLMN identifier and provides the policies to the UE using the UE configuration update procedure for transparent policy delivery.

When the UE is registered to a V-PLMN/SNPN and receives UE policies from the V-PLMN/SNPN which is not within the list of PLMNs the UE applies only V-PLMN/SNPN policies and does not apply any policies provided by the H-PLMN. When the UE de-registers from the V-PLMN/SNPN the UE does not need to store the policies.

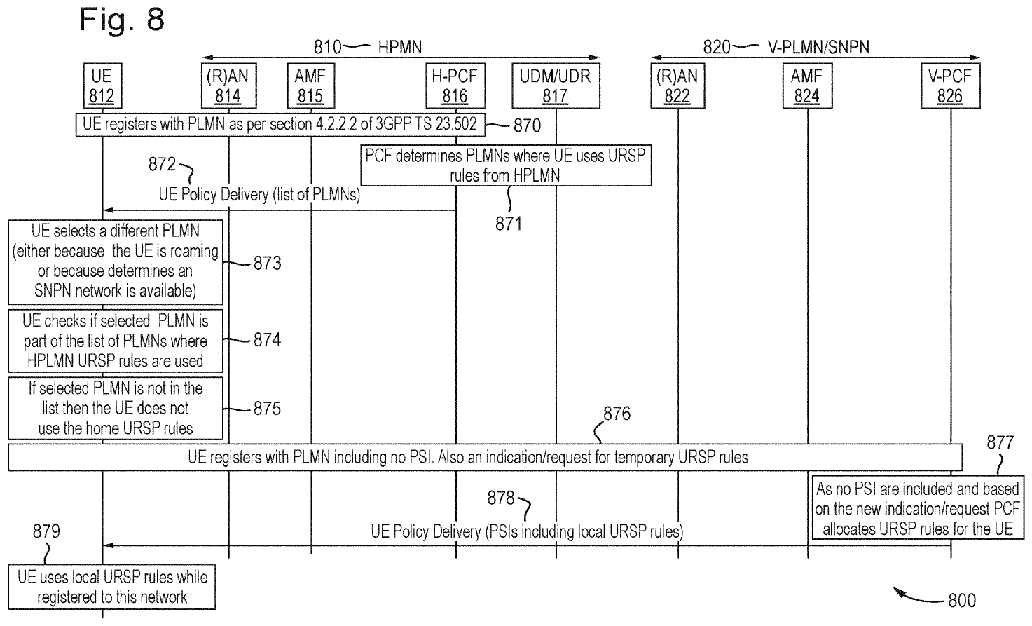

FIG. 8 is a message sequence chart 800 illustrating a method presented herein. FIG. 8 shows a UE 812, an H-PLMN 810 and a V-PLMN 820. The V-PLMN 820 may be an SNPN. The H-PLMN 810 comprises a Radio Access Network (RAN) 814, an Access and Mobility management Function (AMF) 815, a Home Policy Control Function (H-PCF) 816, and a Unified Data Manager/Unified Data Repository (UDM/UDR) 817. The Visited PLMN (V-PLMN) 820 comprises a radio access network (RAN) 822, an Access and Mobility management Function (AMF) 824, and a Visited Policy Control Function (V-PCF) 826.

At 870, the UE 812 registers in the Home PLMN 810 as per section 4.2.2.2 of 3GPP TS 23.502 v17.3.0. The UE 812 includes a list of PSI identifiers associated to the Home PLMN 810.

At 871, the H-PCF 816 determines if new or updated URSP rules are needed. The H-PCF 816 determines, based on operator policy, to include information on which PLMN UE policies provisioned by the H-PCF 816 can be applied.

At 872, the H-PCF 816 provides URSP rules using the UE Configuration Update for transparent policy delivery. The H-PCF 816 includes information to assist the UE 812 to determine on which PLMNs or SNPNs to apply the URSP rules provided by the Home PLMN 810.

At 873, the UE 812 may be roaming or may determine a V-PLMN 820, which may be an SNPN, is nearby. The UE 812 selects the V-PLMN 820 to register.

At 874, the UE 812 checks if the selected V-PLMN 820 is included in the list of PLMNs provided by the H-PCF 816.

At 875, if the selected V-PLMN 820 is not in the list of PLMNs, the UE 812 determines that the URSP rules provided by the H-PLMN 810 are not applicable for this PLMN.

At 876, the UE 812 registers to this V-PLMN 820 including no Policy Section Identifier associated to the Home PLMN 810. The UE 812 may also include an indication or request to include new/temporary URSP rules.

At 877, based on no PSI received at the V-PCF 826 and/or based on the indication/request provided by the UE 812, the V-PCF 826 determines to provide local/temporary URSP rules to the UE 812 even if the UE 812 is from a different PLMN. Those local/temporary URSP rules may be preconfigured in the V-PCF 826 and may be configured per H-PLMN of visiting UE. The local/temporary URSP rules may be based on Service Level Agreements.

At 878, the V-PCF 826 provides temporary URSP rules using the UE configuration update for transparent policy delivery.

At 879, the UE 812 applies the URSP rules only in the selected PLMN, the V-PLMN 820. When the UE 812 de-registers from the selected PLMN the UE 812 does not need to store the local/temporary URSP rules.

After step 879, if the UE 812 registers to a different PLMN that is part of the list of PLMNs provided by the H-PCF 816 the UE registers to the new PLMN using the PSIs associated to the Home PLMN 810 and Visited PLMN 820 (if available) as per procedures in 23.502 v17.3.0.

In step 875 of FIG. 8, if the selected PLMN 820 is within the list of PLMNs, the UE 812 may determine that the URSP rules provided by the H-PLMN 810 can be used and provides the list of PSIs associated to the Home PLMN 810.

In an alternative embodiment when the UE 812 registers with a V-PLMN 820, when the V-PCF 826 receives a UE Policy Association Request from the AMF 824 in the V-PLMN 820 and the V-PCF 826 is able to communicate with the PCF in the H-PLMN 810 via a roaming interface the V-PCF 826 may request of the H-PCF 816 whether it can provide temporary URSP rules to the UE 812. If the H-PCF 816 approves the request the H-PCF 816 may not include UE Policies to the UE 812 or it may provide an indication to the UE 812 that URSP rules received from the V-PCF 826 can be accepted. If the V-PCF 826 receives the acknowledgment for the H-PCF 816 the V-PCF 826 provides URSP rules to the UE 812. The UE 812 prioritizes the URSP rules received from the V-PCF 826 first and then applies the URSP rules from the H-PLMN 810 if these are available. USRP rules are an example of route selection policy rules.

In an alternative, the V-PCF 826 may include service specific information to the H-PCF 816 to construct URSP rules. The H-PCF 816 updates the URSP rules and provisions the updated rules to the UE 812 using a UE configuration update for transparent UE policy delivery procedure.

According to known solutions, URSP rules are provided only by the H-PLMN and the UE applies the same URSP rules in any PLMN that the UE registers to. This may cause problems where, when a UE is roaming, the V-PLMN operator may require a specific traffic routing handling of a specific application. In addition, there are scenarios where a V-PLMN operator cannot interface with the H-PLMN (e.g. in case a UE registers in an SNPN with credentials from the H-PLMN).

The solutions presented herein tend to allow a V-PLMN to be aware that URSP rules can be provided to the UE.

The solutions presented herein tend to allow the H-PLMN to control with which PLMNs the UE can use the rules provided by the H-PLMN, and also how the H-PLMN indicates to the UE to which PLMNs the UE can use the H-PLMN provided rules with.

To address the above issues, the H-PLMN may indicate to the UE with which PLMNs the UE can use UE policies from the H-PLMN. Such an indication may be delivered by providing a list of PLMNs for each provisioned UE policy. When the UE registers to a PLMN that is not within the list of PLMNs the UE does not use the H-PLMN provided policies and instead uses only the V-PLMN provided ones.

According to one arrangement described herein, an H-PLMN provides configuration information on the PLMNs that the UE can request URSP rules from a different PLMN.

According to one arrangement described herein, an H-PLMN provides configuration information on the PLMNs that the UE can apply policy sections from the home PLMN.

Accordingly, there is provide a Policy Control Function in a first mobile communication network arranged to determining PLMNs where a UE is allowed to use URSP rules provisioned from the first mobile communication network; and send a first policy delivery request wherein the request includes a list of PLMN identities where URSP rules provisioned from the first mobile communication network can be used.

There is further provided a UE arranged to register in a first mobile communication network associated with a first PLMN identity, and further arranged to determine if the first PLMN identity is within the list of PLMN identities provisioned from a second PLMN; and to apply URSP rules provisioned from a second PLMN in response to determining that the first PLMN identity is within the list of PLMNs provisioned from a second PLMN.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A user equipment (UE) for wireless communication, comprising:
at least one memory; and
at least one processor coupled with the at least one memory and configured to cause the UE to:
receive from a first wireless communication network at least one route selection policy rule together with a policy delivery request, wherein the policy delivery request includes a list of network identities for which route selection policy rules provisioned from the first wireless communication network are to be applied;
transmit a registration request to a second wireless communication network, where a network identity of the second wireless communication network is not listed in the list of network identities for which route selection policy rules provisioned from the first wireless communication network are to be applied; and
not apply route selection policy rules provisioned from the first wireless communication network.

2. The UE of claim 1, wherein to not apply route selection policy rules provisioned from the first wireless communication network, the at least one processor is configured to cause the UE to inactivate the route selection policy rules provisioned from the first wireless communication network.

3. The UE of claim 1, wherein the at least one processor is configured to cause the UE to request local route selection policy rules from the second wireless communication network.

4. The UE of claim 3, wherein the at least one processor is configured to cause the UE to apply any local route selection policy rules received from the second wireless communication network.

5. The UE of claim 1, wherein the at least one processor is configured to cause the UE to:
transmit a subsequent registration to a third wireless communication network, the third wireless communication network having a network identity listed in the list of network identities for which route selection policy rules provisioned from the first wireless communication network are to be applied; and
apply route selection policy rules provisioned from the first wireless communication network when the UE is registered to the third wireless communication network.

6. The UE of claim 5, wherein the at least one processor is configured to cause the UE to ignore route selection policy rules received from the third wireless communication network.

7. The UE of claim 1, wherein the at least one processor is configured to cause the UE to send to the first wireless communication network an indication that the UE requires route selection policy rules.

8. The UE of claim 1, wherein the at least one processor is configured to cause the UE to receive the route selection policy rules using a UE Configuration Update.

9. A method performed by a user equipment (UE), the method comprising:
receiving from a first wireless communication network at least one route selection policy rule together with a policy delivery request, wherein the policy delivery request includes a list of network identities for which route selection policy rules provisioned from the first wireless communication network are to be applied;
transmitting a registration request to a second wireless communication network, where a network identity of the second wireless communication network is not listed in the list of network identities for which route selection policy rules provisioned from the first wireless communication network are to be applied; and
not applying route selection policy rules provisioned from the first wireless communication network.

10. A network node in a second wireless communication network, the network node comprising:
at least one memory; and
at least one processor coupled with the at least one memory and configured to cause the network node to:
receive a registration request from a user equipment (UE), where a network identity of the second wireless communication network is not listed in a list of network identities for which route selection policy rules provisioned from a first wireless communication network are to be applied; and
register the UE with the second wireless communication network.

11. The network node of claim 10, wherein the at least one processor is configured to cause the network node to receive a request for local route selection policy rules from the UE, and in response thereto, send local route selection policy rules to the UE. equipment apparatus.

12. The network node of claim 10, wherein the at least one processor is configured to cause the network node to send to the first wireless communication network a request for authorization to provide local route selection policy rules to the UE.

13. The network node of claim 12, wherein the at least one processor is configured to cause the network node to send the local route selection policy rules using a UE Configuration Update.

14. (canceled)

15. A processor for wireless communication, comprising:
at least one controller coupled with at least one memory and configured to cause the processor to:
receive from a first wireless communication network at least one route selection policy rule together with a policy delivery request, wherein the policy delivery request includes a list of network identities for which route selection policy rules provisioned from the first wireless communication network are to be applied;
transmit registration request to a second wireless communication network, where a network identity of the second wireless communication network is not listed in the list of network identities for which route selection policy rules provisioned from the first wireless communication network are to be applied; and
not apply route selection policy rules provisioned from the first wireless communication network.

16. The processor of claim 15, wherein to not apply route selection policy rules provisioned from the first wireless communication network, the at least one controller is configured to cause the processor to inactivate the route selection policy rules provisioned from the first wireless communication network.

17. The processor of claim 15, wherein the at least one controller is configured to cause the processor to request local route selection policy rules from the second wireless communication network.

18. The processor of claim 17, wherein the at least one controller is configured to cause the processor to apply any local route selection policy rules received from the second wireless communication network.

19. The processor of claim 18, wherein the at least one controller is configured to cause the processor to:
transmit a subsequent registration to a third wireless communication network, the third wireless communication network having a network identity listed in the list of network identities for which route selection policy rules provisioned from the first wireless communication network are to be applied; and
apply route selection policy rules provisioned from the first wireless communication network when a first UE is registered to the third wireless communication network.

20. The processor of claim 19, wherein the at least one controller is configured to cause the processor to ignore route selection policy rules received from the third wireless communication network.

21. The processor of claim 15, wherein the at least one controller is configured to cause the processor to send to the first wireless communication network an indication that a UE requires route selection policy rules.
